(19) United States
(12) Patent Application Publication
(10) Pub. No.: US 2015/0069014 A1
(43) Pub. Date: Mar. 12, 2015

(54) PATTERN FORMATION METHOD, MAGNETIC RECORDING MEDIUM MANUFACTURING METHOD, AND FINE PARTICLE DISPERSION

(71) Applicant: KABUSHIKI KAISHA TOSHIBA, Minato-ku (JP)

(72) Inventors: Kaori KIMURA, Yokohama-shi (JP); Kazutaka TAKIZAWA, Kawasaki-shi (JP); Akira FUJIMOTO, Kawasaki-shi (JP)

(73) Assignee: KABUSHIKI KAISHA TOSHIBA, Minato-ku (JP)

(21) Appl. No.: 14/324,927

(22) Filed: Jul. 7, 2014

Related U.S. Application Data
(63) Continuation-in-part of application No. 14/164,593, filed on Jan. 27, 2014.

(30) Foreign Application Priority Data
Sep. 10, 2013 (JP) 2013-187499
Apr. 25, 2014 (JP) 2014-092056

(51) Int. Cl. C09D 125/06; G11B 5/84; C09D 133/12; G11B 5/855

(52) U.S. Cl. CPC C09D 125/06; G11B 5/855; G11B 5/8404; C09D 133/12; C08K 5/56
USPC 216/22; 427/131; 524/576; 106/287.18; 524/560

(57) ABSTRACT

According to one embodiment, there is provided a pattern formation method including coating a substrate or mask layer with a fine particle coating solution containing fine particles including a protective group having a close surface polarity and containing, on at least surfaces thereof, a material selected from the group consisting of Al, Ti, V, Cr, Mn, Fe, Co, Ni, Zn, Y, Zr, Sn, Mo, Ta, W, Au, Ag, Pd, Cu, Pt and oxides thereof, a viscosity modifier, and a solvent for adjusting mixing of the viscosity modifier and the fine particles having the protective group to form a fine particle layer on the substrate or mask layer.

### CROSS-REFERENCE TO RELATED APPLICATIONS

This application is a Continuation-in-Part application of U.S. patent application Ser. No. 14/164,593, filed Jan. 27, 2014 and based upon and claiming the benefit of priority from Japanese Patent Applications No. 2013-187499, filed Sep. 10, 2013; and No. 2014-092056, filed Apr. 25, 2014, the entire contents of all of which are incorporated herein by reference.

### FIELD

Embodiments described herein relate generally to a pattern formation method, magnetic recording medium manufacturing method, and fine particle dispersion.

### BACKGROUND

Embodiments of the present invention relate to a pattern formation method and magnetic recording medium manufacturing method.

Microstructures regularly arranged at a period of a few nm to a few hundred nm can be applied to various techniques such as a catalyst, antireflection film, electric circuit, and magnetic recording medium. These structures can be formed by, e.g., a method of writing patterns on a resist by using an electron beam lithography apparatus or ultraviolet lithography apparatus, or a method using a self-organization phenomenon of a diblock copolymer or fine particles.

In particular, the use of fine particles in pattern formation has advantages different from those obtained when using a diblock copolymer or resist. For example, when a material for forming fine particles is appropriately selected, it is possible to make the etching selectivity and growth selectivity favorable in a subsequent process.

In the conventional techniques, however, it is difficult to arrange fine particles made of a desired material into a monolayer on a substrate. To regularly arrange fine particles, a viscosity modifier having a high viscosity must be mixed in the fine particles. When using, e.g., Fe fine particles, however, the particles aggregate at the moment the viscosity modifier is mixed, and this makes coating itself difficult. Also, when using, e.g., Au particles, polystyrenes or the like can be substituted as a protective group around the fine particles, but a method like this has the problem that it is difficult to regularly arrange fine particles by spin coating.

### BRIEF DESCRIPTION OF THE DRAWINGS

FIG. 1 is a graph showing the relationship between the molecular weight of polystyrene and the spacing between fine particles;

FIG. 2 is a view showing an example of a periodic pattern formable by a method according to an embodiment;

FIG. 3 is a view showing another example of the periodic pattern formable by the method according to the embodiment;

FIG. 4 is a partially exploded perspective view showing an example of a magnetic recording/reproduction apparatus to which a magnetic recording medium according to the embodiment is applicable;

FIG. 5 is a flowchart showing a method of forming a periodic pattern to be used in the first embodiment;

FIGS. 6A, 6B, 6C, 6D, and 6E are schematic sectional views showing steps of forming a magnetic recording medium according to the first embodiment;

FIGS. 7A, 7B, 7C, and 7D are schematic sectional views showing steps of forming a magnetic recording medium according to the second embodiment;

FIG. 8 shows an SEM photograph of a fine particle layer used in the embodiment;

FIG. 9 shows an SEM photograph of a fine particle layer used as a comparative example; and

FIGS. 10A, 10B, 10C, and 10D are schematic sectional views showing modifications of the steps of forming the magnetic recording medium according to the second embodiment.

### DETAILED DESCRIPTION

Embodiments will be explained below.

A magnetic recording medium manufacturing method according to the first embodiment includes

forming a magnetic recording layer on a substrate,

forming a mask layer on the magnetic recording layer,

coating the mask layer with a fine particle coating solution containing fine particles including a protective group having a surface polarity close to that of the mask layer and containing, on at least surfaces thereof, a material selected from the group consisting of aluminum, titanium, vanadium, chromium, manganese, iron, cobalt, nickel, zinc, yttrium, zirconium, tin, molybdenum, tantalum, tungsten, gold, silver, palladium, copper, platinum, and oxides thereof, a viscosity modifier, and a solvent for adjusting mixing of the viscosity modifier and the fine particles having the protective group, thereby forming a fine particle monolayer on the mask layer,

transferring a periodic pattern formed by the fine particle layer to the mask layer,

transferring the periodic pattern to the magnetic recording layer, and

removing the mask layer from the magnetic recording layer.

In the first embodiment, a periodic pattern in which fine particles are arranged without any aggregation in a fine particle monolayer is obtained. Accordingly, a patterned medium in which the size distribution of magnetic particles is low is obtained.

The “periodic pattern” herein mentioned is a pattern array having a predetermined regularity. The pattern can be one or both of a projection-and-recess pattern and a pattern of materials having different chemical compositions. For example, when Fe particles are arranged as they are buried in a polymethylmethacrylate matrix, an array of materials having different chemical compositions is obtained although there are neither projections nor recesses. Also, when the polymethylmethacrylate matrix is removed by an RIE process, only the Fe particles remain to form a projection-and-recess pattern. The “predetermined regularity” means that an array of projections and recesses or an array of materials having different chemical compositions is formed. The array can be a hexagonal close-packed array or square array. The array includes at least 100 or more patterns. A regularly arranged region is called a domain, and a fine particle array in the embodiment can have a plurality of domains. The array is disturbed in the boundary between domains.

A magnetic particle is a region in a magnetic recording layer where the magnetic material causes magnetization reversal as a single particle. An example is a magnetic particle having a regular structure. The regular structure can be a single crystal, a film including alternately stacked layers such as an L1₀ structure, or an artificial lattice holding the same orientation. Also, in a structure such as a granular medium in which magnetic grains are buried in a nonmagnetic matrix, a magnetic portion in the matrix is the magnetic particle mentioned in the embodiment. The particle size distribution of the magnetic particles is directly connected to jitter noise in recording/reproduction. A medium having a small particle size distribution is ideal. In the embodiment, the magnetic recording layer is divided by using the periodic pattern of the fine particles. Therefore, the particle size distribution of the fine particles is almost equal to the grain size distribution of the magnetic grains.

Furthermore, the mask layer is a layer to which the fine particle coating solution is applied, and can be either a monolayer or multilayer film as needed.

In this embodiment, fine particles can be arranged by coating by forming the protective group compatible with the mask layer around the fine particles, and dispersing the fine particles in the solvent in which the viscosity modifier having a desired viscosity is mixed. To well mix the viscosity modifier and protective group, the solubility between the solvent and the protective group and viscosity modifier is adjusted. Consequently, the fine particles can be arranged on a substrate as they are most closely packed at a high density. Alternatively, it is possible to arrange the fine particles not most closely but regularly depending on the coating conditions.

Also, fine particles can be applied as a template for forming a nanostructure in a device having the nanostructure such as a patterned medium. When arranging fine particles into a monolayer on a substrate, the wettability and adhesion between the fine particles and substrate are problems. If the adhesion is too strong, the fine particles are singly adsorbed to the substrate and are not arranged. If the adhesion is weak, however, the fine particles do not remain on the substrate. In the embodiment, the protective group having a surface polarity close to that of the substrate or mask layer is chemically combined around the fine particles. This makes it possible to form a monolayer by coating. In addition, the fine particles can regularly be arranged by mixing the viscosity modifier having a high viscosity in the fine particle dispersion. Particles having a diameter of 10 nm or less arranged by this method can be used as a template of a magnetic recording medium.

The second embodiment provides a magnetic recording medium manufacturing method includes

coating a substrate with a fine particle coating solution containing fine particles including a protective group having a surface polarity close to that of the substrate and containing, on at least surfaces thereof, a material selected from the group consisting of aluminum, titanium, vanadium, chromium, manganese, iron, cobalt, nickel, zinc, yttrium, zirconium, tin, molybdenum, tantalum, tungsten, gold, silver, palladium, copper, platinum, and oxides thereof, a viscosity modifier, and a solvent for adjusting mixing of the viscosity modifier and the fine particles having the protective group, thereby forming a fine particle monolayer on the substrate, and forming a periodic pattern by the fine particles, and

forming a magnetic recording layer on the periodic pattern.

In the second embodiment, as in the first embodiment, fine particles can be arranged by coating by forming the protective group compatible with the substrate around the fine particles, and dispersing the fine particles in the solvent in which the viscosity modifier having a desired viscosity is mixed. Consequently, a periodic pattern in which the fine particles are arranged without any aggregation in the fine particle monolayer is obtained. This makes it possible to obtain a patterned medium in which the particle size distribution is low.

The substrate is a layer to which the fine particle coating solution is to be applied, and can be either a monolayer or multilayer film as needed.

The third embodiment provides a pattern formation method including coating a substrate with a fine particle coating solution containing fine particles including a protective group having a surface polarity close to that of the substrate and containing, on at least surfaces thereof, a material selected from the group consisting of aluminum, titanium, vanadium, chromium, manganese, iron, cobalt, nickel, zinc, yttrium, zirconium, tin, molybdenum, tantalum, tungsten, gold, silver, palladium, copper, platinum, and oxides thereof, a viscosity modifier, and a solvent for adjusting mixing of the viscosity modifier and the fine particles having the protective group, thereby forming a fine particle layer on the substrate.

When the pattern formation method according to the third embodiment is used, a periodic pattern in which fine particles are arranged without any aggregation is obtained.

The substrate is a layer whose surface is to be coated with the fine particle coating solution, and includes a layer that finally forms a periodic pattern together with fine particles, a layer to be processed into a periodic pattern, or a stack including a layer to be finally processed into a periodic pattern and a layer to be removed from the former layer.

Also, the fine particle layer can be either a monolayer or multilayer film as needed. When applying a periodic pattern to a magnetic recording medium, the fine particle layer can be formed as a monolayer.

Also, in the fourth embodiment, a fine particle dispersion containing fine particles including a protective group having a surface polarity close to that of the substrate and containing, on at least surfaces thereof, a material selected from the group consisting of aluminum, titanium, vanadium, chromium, manganese, iron, cobalt, nickel, zinc, yttrium, zirconium, tin, molybdenum, tantalum, tungsten, gold, silver, palladium, copper, platinum, and oxides thereof, a viscosity modifier, and a solvent for adjusting mixing of the viscosity modifier and the fine particles having the protective group is obtained.

Before the step of forming the fine particle layer, the method can further include a step of dispersing a protective group material and fine particles in a solvent, and bringing the protective group material and fine particles into contact with each other in the dispersion, thereby bonding the protective group to the fine particles, a step of adjusting the concentration of the dispersion of the fine particles having the protective group, and a step of preparing the above-mentioned fine particle coating solution by mixing a viscosity modifier in the dispersion of the fine particles having the protective group.

In the step of adjusting the concentration of the dispersion of the fine particles having the protective group, it is possible to remove the solvent by precipitating the fine particles having the protective group by centrifugal separation, and dilute the dispersion of the fine particles having the protective group by adding a solvent until the concentration of the dispersion becomes a desired value.

### Fine Particles

The fine particles to be used in the embodiments are fine particles having a particle size of 1 nm to 1 μm. The shape is often a sphere, but it is also possible to use a shape such as a tetrahedron, rectangular parallelepiped, octahedron, triangular prism, hexagonal prism, or cylinder. When regularly arranging fine particles, the symmetry of the shape can be increased. To improve the arrangement properties during coating, the particle size dispersion can be decreased. When using fine particles in an HDD medium, for example, the particle size dispersion can be set at 20% or less, and can also be set at 15% or less. When the particle size dispersion is low, the jitter noise of the HDD medium can be reduced. If the dispersion exceeds 20%, there is no merit of the particle size dispersion when compared to conventional media manufactured by sputtering.

As the material of the fine particles, it is possible to use a metal, an inorganic material, or a compound thereof. Practical examples of the material are Al, Ti, V, Cr, Mn, Fe, Co, Ni, Zn, Y, Zr, Sn, Mo, Ta, W, Au, Ag, Pd, Cu, and Pt. It is also possible to use oxides, nitrides, borides, carbides, and sulfides of these materials. The fine particles can be either crystalline or amorphous. For example, it is possible to use a core-shell fine particle such as a structure in which Fe is covered with FeOₓ (x=1 to 1.5). When using the core-shell fine particle, it is possible to use materials having different compositions, such as a structure in which Fe₃O₄ is covered with SiO₂. Furthermore, a structure having three or more layers such as Co/Fe/FeOₓ can also be formed by oxidizing the surface of a metal core-shell particle such as Co/Fe. When a main component is one of the above-mentioned materials, it is possible to use a compound containing a noble metal such as Pt or Ag, e.g., Fe₅₀Pt₅₀.

Since the fine particles are arranged in a solution system, the fine particles are used as they are stably dispersed in a solution while a protective group (to be described below) is attached to them.

### Protective Group

A functional group for bonding to the particles is attached to the protective group. Examples of the functional group are an amino group, carboxy group, hydroxy group, sulfo group, and thiol group. A strong bond can be obtained because the surface of each particle and the functional group bond to each other. In particular, a carboxy group can strongly react with the base metal on the fine particle surface, and a thiol group can strongly react with the noble metal on the fine particle surface.

The carboxy group (amino group, hydroxy group, sulfo group, or thiol group) side is bonded to the fine particle, and the main chain is used to perform particle spacing adjustment or polarity adjustment for an array. Generally, the polarity can well be explained by using a solubility parameter (SP value). The SP value is large for a material having a large polarity such as water, and small for a material having a small polarity. When arranging fine particles on the surface of carbon (C) or silicon (Si), the SP value of an organic material can be set at 25 MPa^{1/2} or less. As the main chain of the organic material, it is possible to use a material containing one or a plurality of general hydrocarbons (CₙH₂ₙ₊₁), double bonds, or triple bonds, an aromatic hydrocarbon such as polystyrene, or a polymer such as polyester or polyether. Examples of most often used carboxy groups are capric acid, lauric acid, palmitic acid, and stearic acid as saturated hydrocarbons, and palmitoleic acid, oleic acid, linoleic acid, and linolenic acid as unsaturated hydrocarbons. The main chain may also be a polymer such as polyester, polyethylene, epoxy, polyurethane, polystyrene, polypropylene, or polymethylmethacrylate. Favorable examples of polyethers are polyallylether and polyvinylether, and favorable examples of polyesters are polyacrylic ester, polymethacrylic ester, and their derivatives. Since the process makes the protective group to react later, it is possible to use a protective group having a straight-chain structure having few branches. Especially when using polystyrenes, the SP value is close to that of the coating solvent, so the solubility and coating properties are good. When using polystyrenes, thenumber of phenyl groups is equal to or smaller than half of C as the main chain. The number of phenyl groups can also be adjusted by the composition ratio, like that of a random copolymer of styrene and propylene.

A graph showing the relationship between the molecular weight of polystyrene when polystyrenes having various molecular weights were used as the protective group and adhered to Fe fine particles and the fine particle spacing in a fine particle layer formed by using the fine particles will be explained below.

FIG. 1 is the graph showing the relationship between the molecular weight of polystyrene and the fine particle spacing.

For a patterned medium application, for example, if the fine particle spacing is too wide, e.g., exceeds 15 nm, the recording density often decreases. If the fine particle spacing is less than 1 nm, the fine particles tend to aggregate during the process. Accordingly, the molecular weight of the protective group can be set within the range of 100 to 50,000.

When using carboxylic acid, for example, the molecular weight is defined by the main chain, and the number of carbon atoms of the main chain is 20 to 1,000. Carbon of the main chain can be substituted with oxygen, nitrogen, sulfur, phosphorus, or the like. An amino group, hydroxy group, sulfo group, thiol group, and the like can also have a similar main chain. Examples are oleylamine, polystyrene having a hydroxy-group terminal end, polymethylmethacrylate having a sulfo-group terminal end, and thiol-terminated polybutyl acrylate.

The array can be controlled by the number of protective groups to be bonded to the fine particle. The number of protective groups is determined by the number of reactive functional groups (e.g., carboxy groups or thiol groups) of the protective group with respect to the surface area of the fine particles. For particles having a particle size of around 10 nm, the number of protective groups is preferably 0.1 to 100 groups/nm². For a protective group molecule having one functional group which reacts with the fine particle surface, the number of protective groups per surface area is calculated by:

$$Total surface area S of fine particles = surface area of one particle \times number of fine particles = surface area of one particle \times ( total weight of fine particles \text{/} weight of one particle ) = 4 π {r}^{2} \times {m}_{NP} / ( d \times ( 4 π {r}^{3} / 3 ) \\ Number N of protective group molecules = total weight of protective groups \text{/} weight of one protective group molecule = {m}_{L} / {M}_{w} \times {N}_{A} \\ Number of protective groups per surface area of fine particles = N / S$$

where m_{NP}: the total weight of the fine particles, m_{L}:

the total weight of the protective groups, r: the radius of the fine particles, d: the density of a material forming the fine particles, M_{W}: the molecular weight of the protective group, and N_{A}: the Avogadro constant.

### Solvent

As the solvent for dispersing the fine particles, it is possible to use a solvent having a high affinity for the above-described particle protective groups. Since the solution is subjected to coating, it is possible to use not a water-based solvent but an organic solvent. For example, hydrochloric acid is inadequate because it dissolves metal particles. When using a method such as spin coating, the volatility of the solvent can be higher, and the boiling point of the solvent can be set at 200 C or less, and can also be set at 160 C or less. Examples are aromatic hydrocarbon, alcohol, ester, ether, ketone, glycol ether, alicyclic hydrocarbon, and aliphatic hydrocarbon. From the viewpoints of the boiling point and coating properties, it is possible to use, e.g., hexane, toluene, xylene, cyclohexane, cyclohexanone, PGMEA, diglyme, ethyl lactate, methyl lactate, or THF. Coating Method of Fine particles

The substrate is coated with the fine particles by using, e.g., a spin coating method, dip coating method, or LB (Langmuir-Brodgett) method. In the spin coating method, the fine particle dispersion having an adjusted concentration is dropped on the substrate, and the solvent is dried by rotating the substrate. The film thickness is controlled by the rotational speed. In the dip coating method, the substrate is dipped in the dispersion, and the fine particles are adhered to the substrate by the viscous force and intermolecular force when the substrate is pulled up. The film thickness is controlled by the pulling rate. In the LB method, the polarity of the particle protective group and that of the solvent are dissociated from each other to make a state in which a monolayer of the particles floats on the surface. After that, the fine particles are arranged on the substrate by pulling up the dipped substrate.

### Viscosity Modifier

To regularly arrange the fine particles, a material having a high viscosity is mixed in the fine particle dispersion. The viscosity of the material can be measured by a capillary viscometer or rotational viscometer. A viscosity required of the viscosity modifier can generally be set at 10 to 5,000 cps, although it also depends on the concentration of the fine particles to be mixed or the viscosity of the solvent. If the viscosity of the viscosity modifier is less than 10 cps, the viscosity is insufficient and does not contribute to the interaction between the particles, so the particles are not regularly arranged. If the viscosity exceeds 5,000 cps, it becomes difficult to evenly coat the substrate with the liquid.

Also, the viscosity modifier can be uniformly placed between the fine particles, so the molecular weight of the viscosity modifier may be not so large. More specifically, the molecular weight of the viscosity modifier can be set at about 100 to 1,000.

The viscosity modifier can also be polymerizable in order to fix the array of particles. Examples are polymerizable materials having an acryloyl group, methacryloyl group, epoxy group, oxetane ring, vinylether group, and other unsaturated bonds. When these groups are contained, the polymerization reaction between the protective groups progresses by light or heat, so the protective groups can be cured.

Note that this polymerizable material is also usable in an uncured state as long as a desired viscosity can be obtained.

Examples of a resin having a viscosity of 100 to 1,000 cps are acrylate, methacrylate, and their derivatives.

Examples of acrylate are ethylacrylate, isobornylacrylate, phenylacrylate, octylacrylate, tripropyleneglycoldiacrylate, trimethylolpropaneethoxytriacrylate, pentaerythritoltriacrylate, epoxyacrylate, urethaneacrylate, polyesteracrylate, and polyetheracrylate. Examples of methacrylate are methoxypolyethyleneglycolmethacrylate, phenoxyethyleneglycolmethacrylate, stearylmethacrylate, ethyleneglycoldimethacrylate, triethyleneglycoldimethacrylate, polyethyleneglycolmethacrylate, ethoxylated bisphenol A diacrylate, propyleneglycoldiacrylate, trimethylolpropanetrimethacrylate, polyestermethacrylate, polyethermethacrylate, epoxymethacrylate, and urethanemethacrylate.

Examples of the polymerizable material having an epoxy group are epoxyacrylate, epoxyethane, alcoholglycidylether, ethyleneglycolglycidylether, and polyethyleneglycolglycidylether.

Examples of the polymerizable material having an oxetane ring are 3-ethyl-3-hydroxymethyloxetane and 3-ethyl-chloromethyloxetane.

Examples of the polymerizable material having a vinylether group are 2-hydroxyethylvinylether, diethyleneglycolmonovinylether, and 4-hydroxybutylvinylether.

Since the disturbance of an array caused by the Brownian motion of the fine particles tends to occur when the viscosity is low, it becomes more necessary to cure the viscosity modifier as the viscosity decreases. For example, curing can be performed when the viscosity of the viscosity modifier in the form of an undiluted solution is 1,000 cps or less.

To uniformly mix the viscosity modifier and fine particles, the SP value of the viscosity modifier can be not so high. However, the SP value tends to increase when the number of polymerizable functional groups increases. If the SP value is less than 18 (MPa)^{1/2}, groups necessary for polymerization often reduce. If the SP value is larger than 25 (MPa)^{1/2}, the wettability to the substrate often worsens.

### Method of Curing Viscosity Modifier

The polymerizable resin filled around the fine particles can be cured by radiating general UV light. The UV light is light having a wavelength of 200 to 400 nm. For example, when using phenol modified acrylate, the polymerizable resin can be cured by radiating a UV lamp of 10 to 100 mW/cm² for about a few ten sec. When using a radical polymerization mechanism during curing, it is desirable to perform curing in a vacuum or in a state in which no oxygen enters by forming a protective layer as a cover, in order to prevent curing inhibition by oxygen.

It is also possible to cure the protective group by heating. For example, when using a material such as isobutyl acrylate, the protective group can be cured by performing heating at 150 C for about 30 min to a few hrs in an oven containing an N2 ambient.

### Hard Mask

A hard mask layer can be formed between the substrate and fine particle layer as needed. When the hard mask layer is formed, it is possible to secure a mask height and taper a pattern.

The hard mask is formed by depositing a film including at least one layer on a recording layer by a method such as sputtering. When the hard mask must have a height to some extent, it is possible to give the hard mask a structure including two or more layers. For example, a mask having a high aspect can be formed by using C as a lower layer and Si as an upper layer. Alternatively, when using a metal such as Ta, Ti, Mo, or W or a compound thereof as the lower layer, a material such as Ni or Cr can be used as the upper layer. The use of a metal material as the mask has the advantage that the deposition rate increases.

When using the hard mask as an ion milling hard mask, C, Ta, Ti, or a compound thereof is used as the hard mask. When using the hard mask as not an etching mask but a pattern layer for depositing a magnetic film on it, it is possible to use Al, Fe, Ni, or Sn on the surface of which an oxidation film is formed, a noble metal such as Au, Ag, Pt, Pd, or Ru that hardly oxidizes, or a material such as C or Si.

### Patterning of Hard Mask

The hard mask can be patterned by using various dry etching processes as needed. For example, when the hard mask is C, dry etching can be performed by using an oxygen-based gas such as O₂ or O₃, or a gas such as H2 or N2. When the hard mask is Si, Ta, Ti, Mo, or W, RIE can be performed by using a halogen gas (CF₄, CF₄/O₂, CHF₃, SF₆, or Cl₂). When using a compound of Cr or Al as the hard mask, RIE using a Cl-based gas can be performed. Also, ion milling using a rare gas is effective when using a noble metal such as Au, Pt, Pd, or Cu.

Patterning of Magnetic. Recording Layer

In the patterning of the magnetic recording layer, patterns are formed by projections and recesses on the recording layer by etching unmasked portions by ion milling or RIE. “Patterns are formed by projections and recesses” normally means that the material of the recording layer is entirely etched. In some cases, it is also possible to form a structure in which the material of the recording layer is partially left behind in the recesses, or a structure such as a capped structure in which the first layer is entirely etched and layers from the second layer are left behind.

In ion milling, it is possible to use a rare gas such as Ne, Ar, Kr, or Xe, or an inert gas such as N₂. When using RIE, a gas such as a Cl₂-based gas, CH₃OH, or NH₃+CO is used. RIE sometimes requires H₂ gas cleaning, baking, or washing with water after etching.

### Filling Step

A process of planarizing a periodic pattern by filling can be added after the periodic pattern is formed. As this filling, sputtering using a filling material as a target is used because the method is simple. However, it is also possible to use, e.g., plating, ion beam deposition, CVD, or ALD. When using CVD or ALD, the filling material can be deposited at a high rate on the sidewalls of the highly tapered magnetic recording layer. Also, high-aspect patterns can be filled without any gap by applying a bias to the substrate during filling deposition. It is also possible to use a method by which a so-called resist such as SOG (Spin-On-Glass) or SOC (Spin-On-Carbon) is formed by spin coating and cured by annealing.

The filling material is not limited to SiO₂, and can be any material as long as the hardness and flatness are allowable. For example, an amorphous metal such as NiTa or NiNbTi is usable as the filling material because the amorphous metal is easy to planarize. When using a material such as CNₓ or CHₓ mainly containing C, the adhesion to DLC often improves because the hardness is high. An oxide or nitride such as SiO₂, SiNₓ, TiOₓ, or TaOₓ is also usable as the filling material. However, if the filling material forms a reaction product together with the magnetic recording layer when brought into contact with the magnetic recording layer, a protective layer can be sandwiched between the filling layer and magnetic recording layer.

### Protective Film and Lubricant

Carbon can be used as the protective layer. The carbon protective film is desirably deposited by CVD in order to improve the coverage for projections and recesses, but can also be deposited by sputtering or vacuum deposition. A DLC film containing a large amount of sp³-bonded carbon is formed by CVD. If the film thickness is 2 nm or less, the coverage worsens. If the film thickness is 10 nm or more, the magnetic spacing between a recording/reproduction head and the medium increases, and the SNR often decreases.

Also, the protective film can be coated with a lubricant. As the lubricant, it is possible to use, e.g., perfluoropolyether, alcohol fluoride, or fluorinated carboxylic acid.

### Magnetic Recording Layer

When using an alloy-based material as the magnetic recording layer, the material can contain Co, Fe, or Ni as a main component, and can also contain Pt or Pd. The magnetic recording layer can contain Cr or an oxide as needed. As the oxide, silicon oxide or titanium oxide can be used. In addition to the oxide, the magnetic recording layer can further contain one or more elements selected from Ru, Mn, B, Ta, Cu, and Pd. These elements can improve the crystallinity and orientation, and make it possible to obtain recording/reproduction characteristics and thermal decay characteristics for high-density recording.

As the perpendicular magnetic recording layer, it is possible to use a CoPt-based alloy, an FePt-based alloy, a CoCrPt-based alloy, an FePtCr-based alloy, CoPtO, FePtO, CoPtCrO, FePtCrO, CoPtSi, FePtSi, and a multilayer structure including Co, Fe, or Ni and an alloy mainly containing at least one element selected from the group consisting of Pt, Pd, Ag, and Cu. It is also possible to use an MnAl alloy, SmCo alloy, FeNbB alloy, or CrPt alloy having a high Ku.

The thickness of the perpendicular magnetic recording layer can be 3 to 30 nm, and can also be 5 to 15 nm. When the thickness falls within this range, it is possible to manufacture a magnetic recording/reproduction apparatus for a high recording density. If the thickness of the perpendicular magnetic recording layer is less than 3 nm, the reproduced output is too low, and the noise component often becomes higher. If the thickness of the perpendicular magnetic recording layer exceeds 30 nm, the reproduced output often becomes too high and distorts the waveform.

### Soft Under Layer

The soft under layer (SUL) horizontally passes a recording magnetic field from a single-pole head for magnetizing the perpendicular magnetic recording layer, and returns the magnetic field toward the magnetic head, i.e., performs a part of the function of the magnetic head. The soft under layer has a function of applying a steep sufficient perpendicular magnetic field to the recording layer, thereby increasing the recording/reproduction efficiency.

A material containing Fe, Ni, or Co can be used as the soft under layer. Examples of the material of the soft under layer are FeCo-based alloys such as FeCo and FeCoV, FeNi-based alloys such as FeNi, FeNiMo, FeNiCr, and FeNiSi, FeAl-based and FeSi-based alloys such as FeAl, FeAlSi, FeAlSiCr, FeAlSiTiRu, and FeAlO, FeTa-based alloys such as FeTa, FeTaC, and FeTaN, and FeZr-based alloys such as FeZrN. It is also possible to use a material having a microcrystalline structure or a granular structure in which fine crystal grains are dispersed in a matrix. Examples are FeAlO, FeMgO, FeTaN, and FeZrN containing 60 at % or more of Fe. Other examples of the material of the soft under layer are Co alloys containing Co and at least one of Zr, Hf, Nb, Ta, Ti, and Y. The Co alloy can contain 80 at % or more of Co. When the Co alloy like this is deposited by sputtering, an amorphous layer readily forms. The amorphous soft magnetic material has none of magnetocrystalline anisotropy, a crystal defect, and a grain boundary, and hence has very high soft magnetism and can reduce the noise of the medium. Examples of the amorphous soft magnetic material are CoZr—, CoZrNb-, and CoZrTa-based alloys.

It is also possible to additionally form a base layer below the soft under layer, in order to improve the crystallinity of the soft under layer or improve the adhesion to the substrate. As the material of this base layer, it is possible to use Ti, Ta, W, Cr, Pt, an alloy containing any of these elements, or an oxide or nitride of any of these elements.

In order to prevent spike noise, it is possible to divide the soft under layer into a plurality of layers, and insert a 0.5- to 1.5-nm thick Ru layer, thereby causing antiferromagnetic coupling between them. The soft magnetic layer may also be exchange-coupled with a hard magnetic film having in-plane anisotropy such as CoCrPt, SmCo, or FePt, or with a pinned layer made of an antiferromagnetic material such as IrMn or PtMn. To control the exchange coupling force, it is possible to stack magnetic films (e.g., Co) or nonmagnetic films (e.g., Pt) on the upper and lower surfaces of the Ru layer.

### Interlayer

An interlayer made of a nonmagnetic material can be formed between the soft under layer and perpendicular magnetic recording layer. The interlayer has two functions, i.e., interrupts the exchange coupling interaction between the soft under layer and recording layer, and controls the crystallinity of the recording layer. As the material of the interlayer, it is possible to use Ru, Pt, Pd, W, Ti, Ta, Cr, Si, Ni, Mg, an alloy containing any of these elements, or an oxide or nitride of any of these elements.

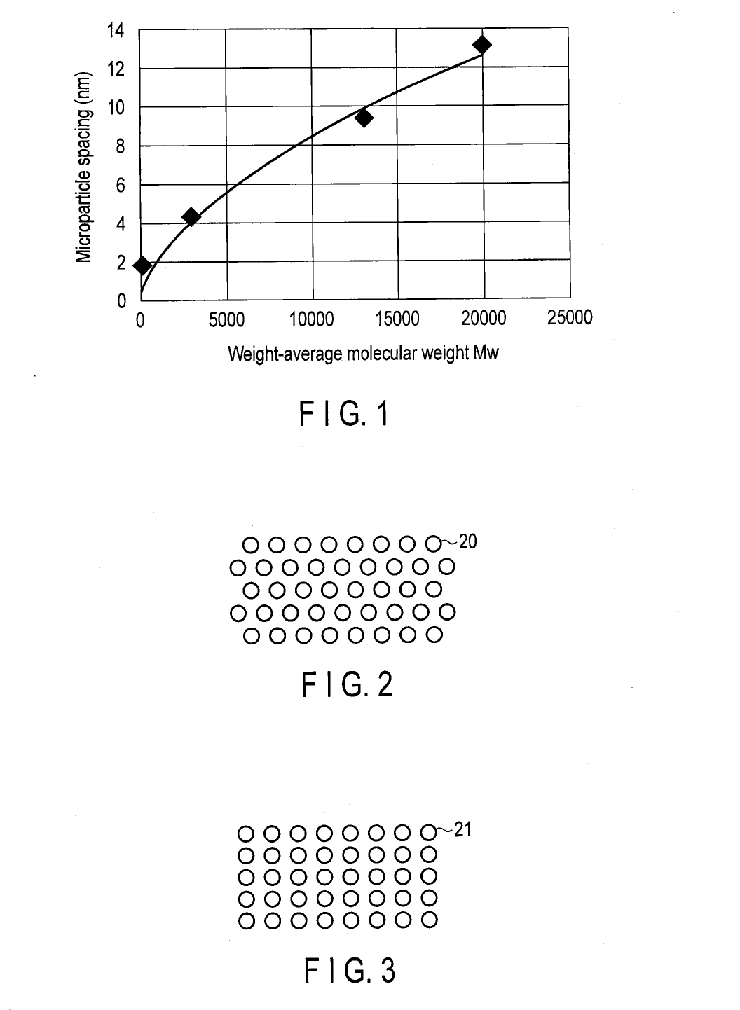

FIG. 2 is a view showing an example of a periodic pattern formable by the method according to the embodiment.

As shown in FIG. 2, when using the method according to the embodiment, a pattern in which, for example, fine particles 20 are hexagonally closely packed at a pitch of a few nm to a few ten nm can be formed at once in a large area.

FIG. 3 is a view showing another example of the periodic pattern formable by the method according to the embodiment.

In the periodic pattern of this example, fine particles 21 form a square array. This pattern can be formed when the shape of fine particles used is a cube (not shown).

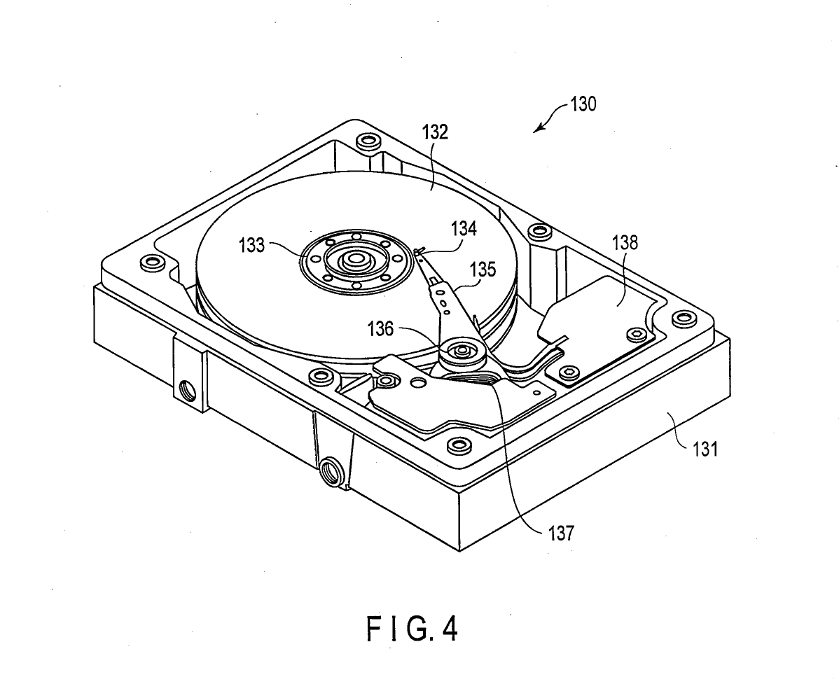

FIG. 4 is a partially exploded perspective view showing an example of a magnetic recording/reproduction apparatus to which the magnetic recording medium according to the embodiment is applicable.

As shown in FIG. 4, a magnetic recording/reproduction apparatus 130 includes a rectangular boxy housing 131 having an open upper end, and a top cover (not shown) that is screwed to the housing 131 by a plurality of screws and closes the upper-end opening of the housing.

The housing 131 houses, e.g., a magnetic recording medium 132 according to the embodiment, a spindle motor 133 as a driving means for supporting and rotating the magnetic recording medium 132, a magnetic head 134 for recording and reproducing magnetic signals with respect to the magnetic recording medium 132, a head actuator 135 that has a suspension on the distal end of which the magnetic head 134 is mounted and supports the magnetic head 134 such that it can freely move with respect to the magnetic recording medium 132, a rotating shaft 136 for rotatably supporting the head actuator 135, a voice coil motor 137 for rotating and positioning the head actuator 135 via the rotating shaft 136, and a head amplifier circuit board 138.

The embodiments will be explained in more detail below by way of their examples.

### Example 1

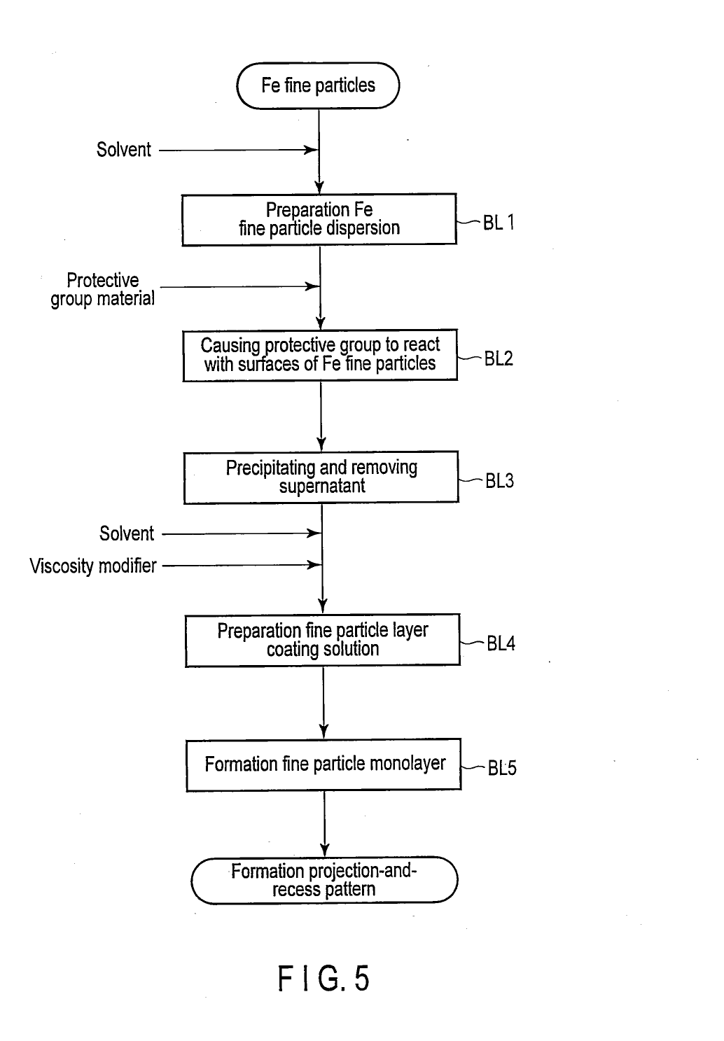

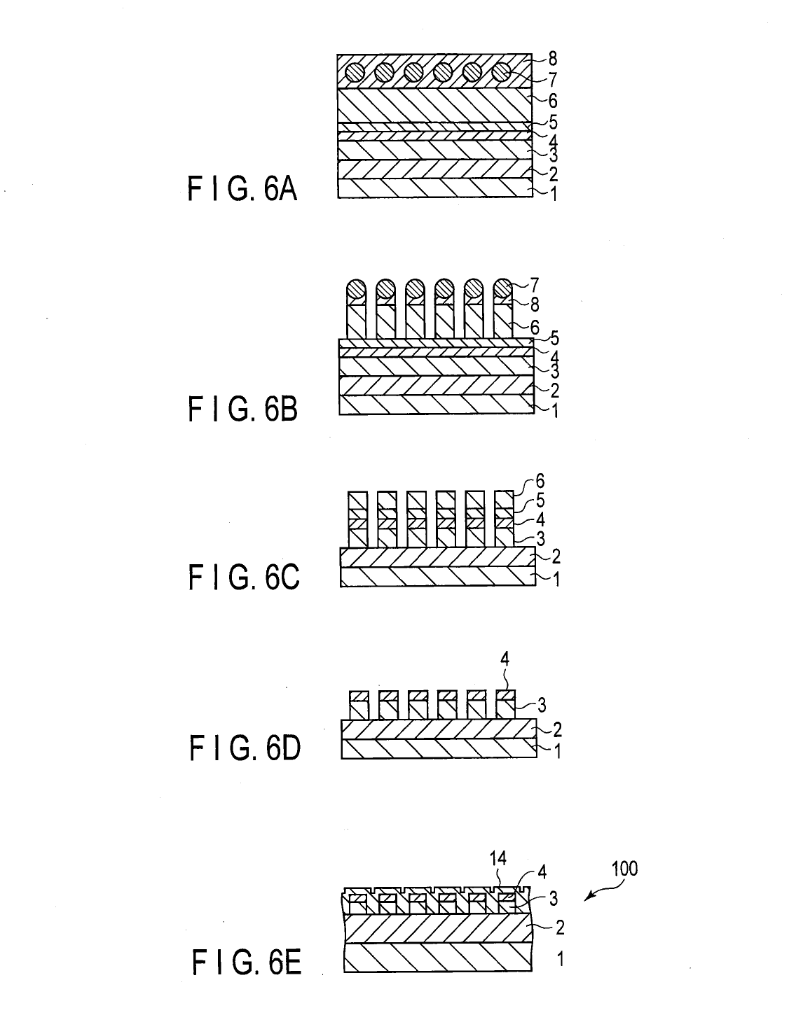

An example of the magnetic recording medium manufacturing method according to the first embodiment will be explained with reference to FIGS. 5, 6A, 6B, 6C, 6D, and 6E.

FIG. 5 is a flowchart showing a method of forming a periodic pattern to be used in the first embodiment.

First, Fe fine particles (particle size=6 nm) having an oleylamine protective group were dispersed at 0.1 wt % in toluene as a solvent, thereby forming an Fe fine particle dispersion (BL 1).

Then, polystyrene (molecular weight=1,000) having a carboxy group terminal end was dispersed at 1 wt % in a toluene solvent, thereby forming a protective group material dispersion. This protective group material dispersion and the above-mentioned dispersion were mixed at a weight ratio of 1:1. The obtained protective group material-Fe particle dispersion was stirred in an argon ambient for 1 hr, thereby causing the carboxy group and Fe particle surfaces to react with each other (BL 2). It was confirmed by a TEM that this reaction formed a 2 to 3 nm thick oxide on the surface of each Fe particle. Polystyrene was probably bonded to the surface of this oxide layer. Since this oxidation of the surface increased the thickness, the Fe particle diameter changed to 10 nm.

Subsequently, the fine particles were precipitated by centrifugal separation (9,000 rpm, 10 min), and the supernatant was entirely removed (BL 3).

After that, the fine particle dispersion was diluted with toluene to have a desired concentration, i.e., concentration adjustment was performed so that the concentration was 1 wt %.

In addition, ethoxylated(6)trimethylolpropane triacrylate (to be referred to as E6TAPA hereinafter) was mixed as a viscosity modifier at a ratio of 1:1 with respect to the weight of the fine particles, thereby preparing a fine particle layer coating solution (BL 4).

The fine particle layer coating solution was dropped on a glass substrate on which a magnetic recording layer and mask layer were deposited, and spin coating was performed at a rotational speed of 3,000 rpm, thereby forming a fine particle monolayer (BL 5).

It was confirmed by SEM observation that the fine particles were arranged into a monolayer on the mask layer.

FIGS. 6A, 6B, 6C, 6D, and 6E are schematic sectional views showing steps of forming a patterned magnetic recording medium by using the above-mentioned periodic pattern.

Subsequently, the aforementioned periodic pattern was transferred to the magnetic recording layer.

Note that the film configuration of the magnetic recording medium having the magnetic recording layer to which the periodic pattern was to be transferred included a 40-nm thick soft magnetic layer (CoZrNb) (not shown), 20-nm thick Ru orientation control interlayer 2, 10-nm thick Co₈₀Pt₂₀ magnetic recording layer 3, 2-nm thick Pd protective film 4, 3-nm thick Mo liftoff layer 5, and 10-nm thick first hard mask layer 6 made of C stacked in this order on a glass substrate 1.

First, FIG. 6A shows a state in which the regular array pattern including a fine particle layer 7 and a protective layer 8 buried around the fine particle layer 7 was formed on the first hard mask layer 6.

As shown in FIG. 6B, the pattern of the Fe fine particle layer 7 was transferred to the C mask 6 by dry etching. For example, this step was performed for an etching time of 30 sec by an inductively coupled plasma (ICP) RIE apparatus by using O₂ gas as a process gas at a chamber pressure of 0.1 Pa, a coil RF power of 100 W, and a platen RF power of 10 W. Since the Fe particles were hardly etched by O₂ plasma, the mask was formed such that the Fe particle having a diameter of 10 nm was placed on a C pillar having a height of 10 nm.

Then, as shown in FIG. 6C, the shape of the first hard mask C was transferred to the magnetic recording layer 3 by ion milling. For example, this step was performed for an etching time of 20 sec by an Ar ion milling apparatus by using Ar as a process gas at a chamber pressure of 0.04 Pa, a plasma power of 400 W, and an acceleration voltage of 400 V. In this step, the Mo liftoff layer 5, Pd protective layer 4, and CoPt magnetic recording layer 3 were etched, and the CoPt recording layer 3 was magnetically divided.

Subsequently, as shown in FIG. 6D, the first hard mask 6 was removed together with the liftoff layer 5 made of Mo. For example, this step was performed by dipping the medium in a hydrogen peroxide solution having a concentration of 0.1%, and holding the medium in it for 5 min.

Finally, as shown in FIG. 6E, a 5-nm thick second protective film 14 made of DLC was formed by CVD (Chemical Vapor Deposition) and coated with a lubricant, thereby obtaining a patterned medium 100 according to the first embodiment.

When the planar structure of the patterned medium manufactured by the method as described above was observed with an SEM, the dispersion of the CoPt particle sizes was 10%.

Also, the manufactured magnetic recording medium was incorporated into a drive, and the SNR was measured. Consequently, the SNR was 10 dB at a recording density of 500 kFCl, i.e., the manufactured medium was usable as a magnetic recording medium.

This result shows that a patterned magnetic recording medium having a periodic pattern in which the size distribution of magnetic particles is low and the in-plane uniformity is high can be obtained from the periodic pattern of the fine particle layer formed by the embodiment.

### Example 2

A substrate was coated with a monolayer of fine particles following the same procedures as shown in FIG. 5 except that the materials to be used were changed as follows.

First, ZnO nanoparticles having a particle size of 6 nm were dispersed at a concentration of 1 wt % in a THF (Tetrahydrofuran) solvent. This nanoparticle had hexadecylamine as a protective group.

Then, CₙH₂ₙ₋₁ (n˜50) at the carboxy-group terminal end was dispersed at a concentration of 1 wt % in a PGMEA (Propylene Glycol 1-Monomethyl Ether 2-Acetate) solvent. ZnO nanoparticles were mixed in the dispersion, the mixture was stirred in the atmosphere for 1 hr, and the solvent was entirely substituted by PGMEA.

Subsequently, the concentration of the ZnO fine particle dispersion was adjusted to 2.0 wt %. In addition, E6TAPA was mixed at a ratio of 1:2 with respect to the ZnO weight.

The ZnO particle dispersion was dropped on a glass substrate on which a soft magnetic layer was deposited, and the fine particles were arranged into a monolayer by performing spin coating at a rotational speed of 3,000 rpm, thereby forming a periodic pattern by the fine particle layer.

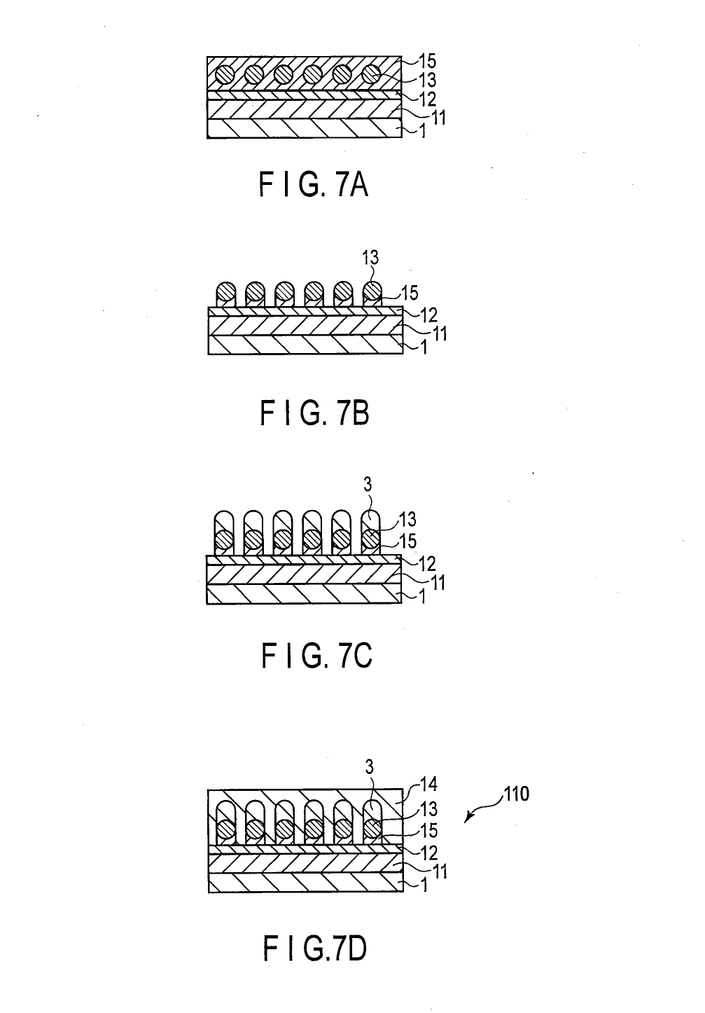

FIGS. 7A, 7B, 7C, and 7D are schematic sectional views showing steps of forming a patterned magnetic recording medium by using the above-mentioned periodic pattern.

First, FIG. 7A shows a state in which a periodic pattern including a fine particle layer 13 and protective layer 15 was formed on a soft magnetic layer 11 and SiC surface oxidation protective group 12.

As shown in FIG. 7B, the protective group 15 around the ZnO particles 13 was etched by dry etching, thereby isolating the particles. For example, this step was performed for an etching time of 10 sec by an inductively coupled plasma (ICP) RIE apparatus by using O₂ gas as a process gas at a chamber pressure of 0.1 Pa, a coil RF power of 100 W, and a platen RF power of 10 W. Since the ZnO particles 13 were hardly etched by O₂ plasma, the ZnO particles 13 were exposed to the substrate surface. This etching stopped when the protective group was removed from at least the upper half portions of the particles.

Subsequently, as shown in FIG. 7C, a magnetic recording layer 3 was deposited on the surfaces of the ZnO particles 13 by sputtering. First, a 3-nm thick Ru layer (not shown) for controlling the crystal orientation was formed, and the magnetic recording layer 3 (total thickness=10 nm) having an artificial lattice obtained by stacking 10 layers of [Co (0.3 nm)/Pt (0.7 nm)] was stacked after that.

Finally, as shown in FIG. 7D, a 5-nm thick second protective film 14 was formed by CVD (Chemical Vapor Deposition) and coated with a lubricant (not shown), thereby obtaining a patterned medium of the second embodiment.

When the planar structure of the patterned medium manufactured by the method as described above was observed with an SEM, the size dispersion of the [Co/Pt] artificial lattice particles was 10%. This result shows that a magnetic recording medium 110 in which the size distribution is low can be obtained from the periodic micropattern according to the embodiment. Examples 3-1 to 3-17 and Comparative Example 1

Whether it was possible to suppress the aggregation of fine particles by the periodic pattern formation method of Example 1 was checked by using Al, Ti, V, Cr, Mn, Fe, Co, Ni, Zn, Y, Zr, Sn, Mo, Ta, and W as the fine particles.

Following the same procedures as in Example 1, polystyrene having a carboxy-group terminal end was mixed in a fine particle dispersion, and a substrate was coated with a monolayer of the mixture. After that, an RIE process was performed, and the presence/absence of an array and aggregation was checked by a planar SEM. Au fine particles were used as Example 3-17.

Although each material can be either an oxide or pure metal, some materials are listed as oxides in examples.

An oxide of metal material A is represented by AOₓ (x changes in accordance with the material, but 0<x≦3 holds in most cases) when the valence is not particularly designated.

Also, the same effect as that of Example 3 was obtained even by a core-shell structure in which the material of Example 3 covered another material (e.g., a noble metal) as in Example 3-16.

TABLE 1

| | | | | Aggregation |
|---|---|---|---|---|
| | Material | Diameter | Array | suppression |
| Example 3-1 | Fe | 10 nm | ⊚ | ◯ |
| Example 3-2 | AlOx | 13 nm | ⊚ | ◯ |
| Example 3-3 | TiOx | 25 nm | ⊚ | ◯ |
| Example 3-4 | VOx | 10 nm | ◯ | ◯ |
| Example 3-5 | CrOx | 20 nm | ◯ | ◯ |
| Example 3-6 | Mn | 30 nm | ◯ | ◯ |
| Example 3-7 | Co | 50 nm | ⊚ | ◯ |
| Example 3-8 | Ni | 10 nm | ◯ | ◯ |
| Example 3-9 | Zn | 50 nm | ◯ | ◯ |
| Example 3-10 | YOx | 50 nm | ◯ | ◯ |
| Example 3-11 | ZrOx | 100 nm | ◯ | ◯ |
| Example 3-12 | Sn | 100 nm | ◯ | ◯ |
| Example 3-13 | Mo | 100 nm | ◯ | ◯ |
| Example 3-14 | Ta | 25 nm | ◯ | ◯ |
| Example 3-15 | WOx | 100 nm | ◯ | ◯ |
| Example 3-16 | FePt(core)/FeOx(shell) | 10 nm | ⊚ | ◯ |
| Example 3-17 | Au | 8 nm | Δ | Δ |

In Table 1, criteria are double circle: a monolayer array and 400 or more particles on average in a regularly arranged region, ◯: a monolayer array and 100 or more particles on average in a regularly arranged region, Δ: a monolayer array was possible, or slightly difficult to obtain, and X: no monolayer array was formed.

Aggregation suppression was checked by measuring a square region of 10-μm side with an SEM, and evaluated by ◯: no aggregation was found, Δ: some aggregation was found, and X: aggregation was found.

When using the particles of Example 3, a monolayer array was good after coating, and no aggregation was found. This result shows that the surfaces of the particles reacted with the carboxy group, and it was possible to secure good coating properties, like Fe particles. Also, no aggregation occurred even when the particles were mixed with a viscosity modifier having a high viscosity, i.e., an aggregation suppressing effect was obtained.

When using Au particles tried as a comparative example, however, the particles aggregated and precipitated with the elapse of time after a dispersion was prepared. This is so because the particles did not react with polystyrene having the carboxy-group terminal end, and the viscosity modifier and Au particles separated.

The above results demonstrate that good coating properties can be obtained by the particles disclosed in this example.

### Examples 4-1 to 4-4 and Comparative Example 2

The method according to the embodiment makes regular array coating possible by improving the adhesion to a substrate by attaching a protective group to fine particles.

Fe fine particles were used as the fine particles, and materials as shown in Table 2 below were used as protective group materials. Following the same procedures as in Example 1, fine particle coating solutions were prepared, and their coating properties were examined. Table 2 below shows results when a C substrate was coated with these solutions.

Also, as Comparative Example 1, a fine particle coating solution was prepared following the same procedures as in Example 1 except that no protective group was attached to the fine particles, and the coating properties were examined. Table 2 also shows this result.

TABLE 2

| | | | Fe:protective | |
|---|---|---|---|---|
| | | | group | |
| | | | (weight | |
| | Material | Solvent | ratio) | Coating |
| Example | Polystyrene | PGMEA | 1:30 | ⊚ |
| 4-1 | | | | |
| Example | Stearic acid | Butyl | 1:10 | ⊚ |
| 4-2 | | lactate | | |
| Example | Oleic acid | Toluene | 1:1 | ◯ |
| 4-3 | | | | |
| Example | Poly-methylmethacrylate | Ethyl | 1:10 | ◯ |
| 4-4 | | lactate | | |
| Com- | None | Toluene | None | X |
| parative | | | | |
| Example 1 | | | | |

In Table 2, a double circle indicates a sample in which a regular array was formed with no coating unevenness in an image obtained at a magnification of ×200,000 by SEM observation, and ◯, Δ, and X indicate samples having one or more defects, three or more defects, and five or more defects, respectively, under the same conditions. When the protective group was attached to the fine particle surfaces, defects were fewer than those when no protective group was used (the comparative example), and uniform coating was possible. This result reveals that the protective group improved the coating properties to the substrate.

### Examples 5-1 to 5-5 and Comparative Example 3

Fine particle coating solutions were prepared and their coating properties were examined following the same procedures as in Example 1, except that materials shown in Table 3 were used as viscosity modifiers. When the viscosity modifier is a polymerizable material that polymerizes by light or heat, the disturbance of the array of particles can be prevented by curing the viscosity modifier. A substrate having a C surface was coated with each coating solution, and the array properties were checked by O₂ RIE. After the process, aggregation suppression was evaluated by observation with a planar SEM. Table 3 below shows the results.

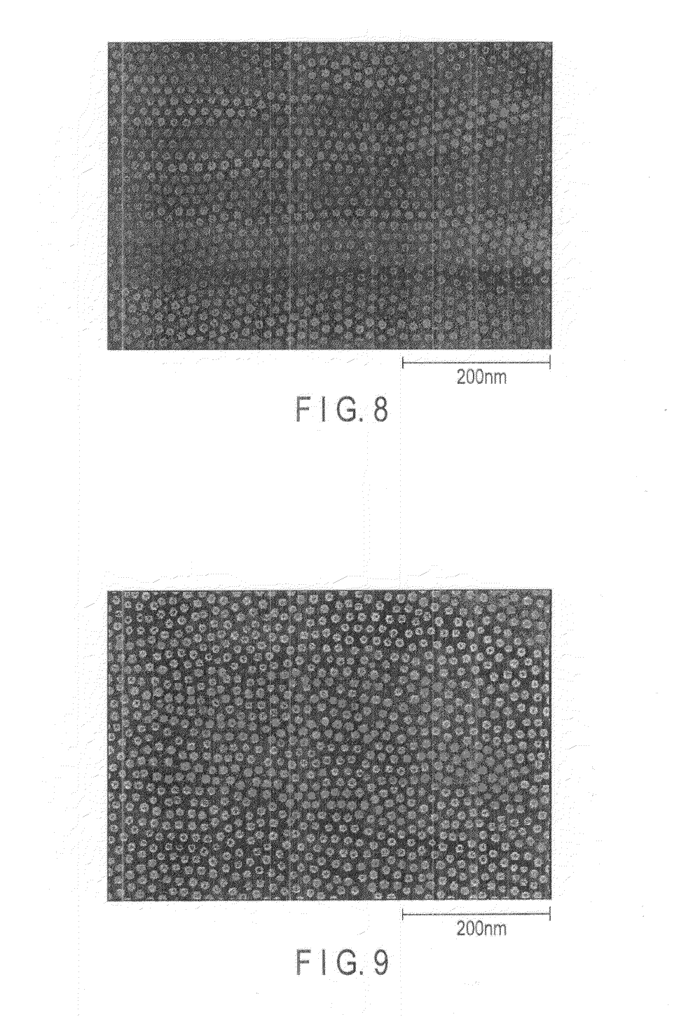

FIG. 8 shows an SEM photograph of the fine particle layer used in the embodiment.

Note that as Comparative Example 2 a fine particle coating solution was prepared following the same procedures as in Example 1 except that no viscosity modifier was used, and aggregation suppression was evaluated by observation with the planar SEM. Table 3 below shows the result.

Also, FIG. 9 shows an SEM photograph of the fine particle layer used as the comparative example.

In the fine particle layer shown in FIG. 8, the fine particles were arranged with no aggregation and had a pitch distribution lower than that in the fine particle layer shown in FIG. 9, i.e., the fine particles shown in FIG. 8 were arranged at a density higher than that of the fine particles shown in FIG. 9.

TABLE 3

| | Main | Molecular | Viscosity | | Aggregation |
|---|---|---|---|---|---|
| | chain | weight | (mPa · s) | Curing | suppression |
| Example 5-1 | E6TAPA | 428 | 60 | Heat | ⊚ |
| Example 5-2 | TMPT | 296 | 80 | UV | ⊚ |
| Example 5-3 | BAEA | 500 | 3000 | None | ◯ |
| Example 5-4 | PT | 298 | 790 | UV | ◯ |
| Example 5-5 | ACMO | 141 | 12 | Heat | ◯ |
| Comparative | None | — | | — | X |
| Example 2 | | | | | |

In Table 3, double circle: a monolayer array and 400 or more particles on average in a regularly arranged region, ◯: a monolayer array and 100 or more particles on average in a regularly arranged region, Δ: a monolayer array was possible, and X: no monolayer array was formed. When compared to Comparative Example 3 containing no viscosity modifier, an aggregation suppressing effect was obtained when the viscosity modifier was contained.

The abbreviations in Table 3 are as follows.

### E6TAPA: Ethoxylated(6)Trimethylolpropane Triacrylate

### TMPT: Trimethylol Propane Triacrylate

### BAEA: Bisphenol A Epoxyacrylate

### PT: Pentaerthritol Triacrylate

### ACMO: Acryloylmorpholine

### Example 6

A carbon nanotube (CNT) was grown by using a fine particle array substrate formed by using the method according to the embodiment.

First, following the same procedures as in Example 1, Fe fine particles were arranged on a substrate in accordance with FIG. 5. However, a silicon substrate having a thermal oxidation film was used instead of the glass substrate, and the substrate was directly coated with the fine particles without depositing any underlayer or the like.

CNT was grown on this fine particle array substrate. First, to expose the surfaces of the fine particles, the protective group and polystyrene on the fine particle surfaces were removed by RIE using O₂ gas. After that, CNT was grown on the fine particle surfaces by CVD using methane gas. It was confirmed by observation with a sectional TEM that CNT was surely grown on the Fe fine particles.

### Example 7

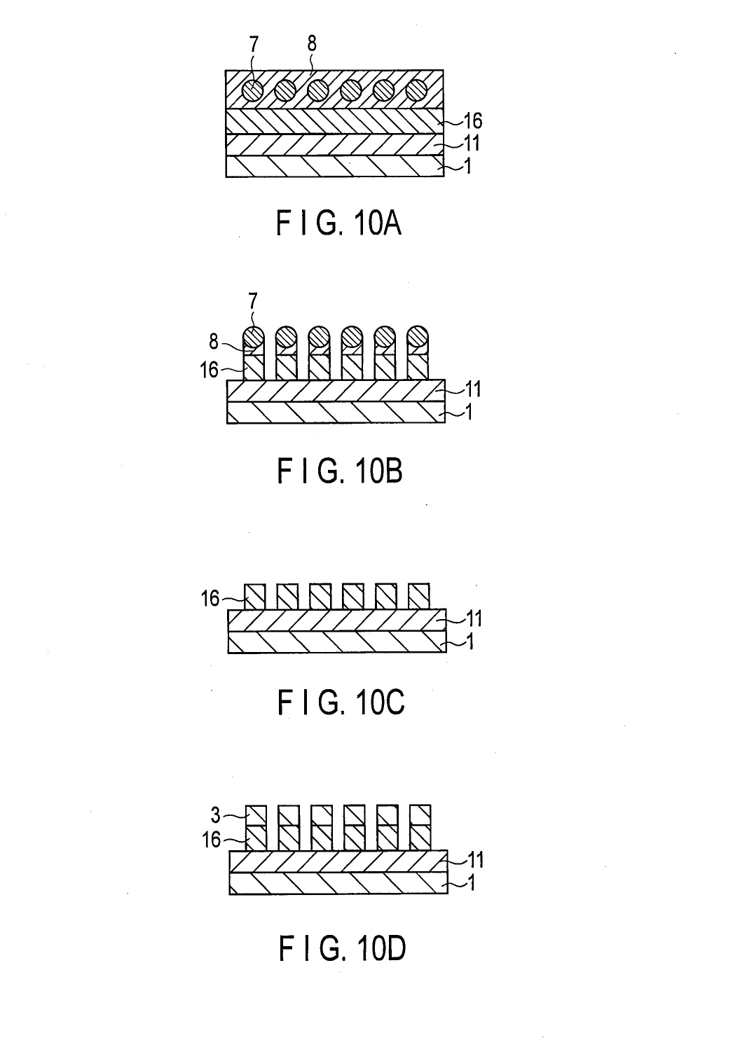

FIGS. 10A, 10B, 10C, and 10D are schematic sectional views showing modifications of the magnetic recording medium manufacturing steps according to the second embodiment.

In this example, after a periodic pattern made of fine particles was formed on an underlayer for processing formed on a substrate, the underlayer for processing was patterned, and the fine particles were removed, instead of forming a periodic pattern by fine particles on a substrate.

A fine particle coating solution was prepared in the same manner as in Example 1.

The configuration of a multilayered structure including a layer to which the fine particle coating solution was to be applied included a 40-nm thick CoZrNb soft magnetic layer 11, 5-nm thick CrTi oxidation protective layer (not shown), and 5-nm thick projection-and-recess formation underlayer 16 made of C stacked in this order on a glass substrate 1.

As shown in FIG. 10A, a periodic pattern including a fine particle layer 7 and protective layer 8 was formed on the projection-and-recess formation underlayer 16 in the same manner as in Example 1.

Then, as shown in FIG. 10B, the pattern of the Fe particles 7 was transferred to the C underlayer 16 by dry etching.

For example, this step was performed for an etching time of 15 sec by an inductively coupled plasma (ICP) RIE apparatus by using O₂ gas as a process gas at a chamber pressure of 0.1 Pa, a coil RF power of 100 W, and a platen RF power of 10 W. Since the Fe particles were hardly etched by O₂ plasma, a mask in which the Fe particle (the surface was oxidized by plasma) having a diameter of 10 nm was placed on a 5-nm thick C pillar 16 was obtained.

Subsequently, as shown in FIG. 10C, the Fe particles 7 were dissolved away to form a structure including only the C pillars 16. For example, this step was performed by dipping the substrate in an aqueous HCl solution having a concentration of 1 wt % for 5 min, thereby selectively dissolving the oxidized Fe particles 7 on the surface. The soft magnetic layer 11 was not dissolved because it was protected by the CrTi protective film.

After that, as shown in FIG. 10D, a magnetic recording layer 3 was deposited on the surfaces of the C pillars 16 by sputtering. First, a 3-nm thick Ru layer for controlling the crystal orientation was stacked, and the magnetic recording layer 3 (total thickness=10 nm) having an artificial lattice obtained by stacking 10 layers of [Co (0.3 nm)/Pt (0.7 nm)] was stacked after that.

Finally, a 5-nm thick second protective film made of DLC was formed by CVD (Chemical Vapor Deposition) and coated with a lubricant, thereby obtaining a patterned medium according to the embodiment.

When the planar structure of the patterned medium manufactured by the method as described above was observed with an SEM, the dispersion of the [Co/Pt] artificial lattice particle sizes was 10%. This result shows that a magnetic recording medium in which the size distribution of magnetic particles is low can be obtained from a micropattern by this embodiment. The manufactured magnetic recording medium was incorporated into a drive, and the SNR was measured. Consequently, the SNR was 8 dB at a recording density of 500 kFCl, i.e., the manufactured medium was usable as a magnetic recording medium. This result shows that a magnetic recording medium having a periodic pattern in which the size distribution is low and the in-plane uniformity is high can be obtained from the micropattern according to the embodiment.

### Example 8

First, Fe fine particles (particle size=6 nm) having an oleylamine protective group were dispersed at 0.1 wt % in toluene as a solvent, thereby forming an Fe fine particle dispersion. Then, polystyrene (molecular weight=1,000) having a carboxy group terminal end was dispersed at 0.005 to 10 wt % in a toluene solvent, thereby forming a protective group material dispersion. After that, the protective group material dispersion and Fe fine particle dispersion were mixed at a weight ratio of 1:1. The obtained protective group material-Fe fine particle dispersion was stirred in an argon ambient for 1 hr, thereby causing the carboxy group and Fe particle surfaces to react with each other.

Subsequently, concentration adjustment was performed so that the concentration of the fine particle dispersion was 1 wt %. First, after the fine particles were precipitated by centrifugal separation (9,000 rpm, 10 min), the solvent was entirely removed, and the dispersion was diluted with toluene so as to have a desired concentration. In addition, E6TAPA was mixed as a viscosity modifier at a ratio of 1:1 with respect to the weight of the fine particles, thereby preparing a fine particle layer coating solution.

This fine particle layer coating solution was dropped on a glass substrate on which a magnetic recording layer and mask layer were deposited, and spin coating was performed at a rotational speed of 3,000 rpm, thereby forming a fine particle monolayer.

When SEM observation was performed, it was confirmed that the fine particles were arranged into a monolayer on the mask layer. It was also confirmed that the way the array was formed changed in accordance with the concentration of the added protective group. The following table shows the concentration of the protective group and the number of protective groups per particle surface area calculated from the concentration.

TABLE 4

| | | Protective | |
|---|---|---|---|
| | Protective | group molecules | |
| | group | per particle | |
| | concentration | surface area | |
| | (wt %) | (molecules/nm²) | Array |
| Example 8-1 | 0.005 | 0.071 | Δ |
| Example 8-2 | 0.007 | 0.099 | Δ |
| Example 8-3 | 0.01 | 0.14 | ◯ |
| Example 8-4 | 0.1 | 1.4 | ⊚ |
| Example 8-5 | 1 | 14 | ⊚ |
| Example 8-6 | 5 | 71 | ◯ |
| Example 8-7 | 8 | 113 | Δ |
| Example 8-8 | 10 | 140 | Δ |

In Table 4, criteria are double circle: a monolayer array and 100 or more particles on average in a regularly arranged region, ◯: a monolayer array and 20 or more particles on average in a regularly arranged region, Δ: a monolayer array was possible, or some aggregation was found, and X: aggregation was found, or no monolayer array was formed.

When the amount of the protective groups was smaller than 0.1 group/nm², the particles readily aggregated. By contrast, when the amount of the protective groups exceeded 100 groups/nm², the protective groups were too many and disturbed the array of the particles. This made a regular array difficult to form. When the amount of the protective groups was 0.1 to 100 groups/nm², the spacings between the particles extended as the protective group amount increased, but the particles were regularly arranged under all conditions.

The above results indicate that a proper amount of the protective groups was 0.1 to 100 groups/nm².

### Example 9

### Noble Metal and Thiol Protective Group

Particles of Au, Ag, Pd, Cu, and Pt were used to check whether it was possible to suppress the aggregation of fine particles by the same periodic pattern formation method as in Example 1.

Following the same procedures as in Example 1, polystyrene having a thiol group terminal end was mixed in a fine particle dispersion, and a substrate was coated with a monolayer of the mixture. After that, an RIE process was performed, and the presence/absence of an array and aggregation was checked by a planar SEM. As Comparative Example 1, Au fine particles in which polystyrene having a carboxy group terminal end was mixed were used.

TABLE 5

| | Fine | Protective | Diameter | | Aggregation |
|---|---|---|---|---|---|
| | particles | group | (nm) | Array | suppression |
| Example 9-1 | Au | Thiol group | 8 | ⊚ | ◯ |
| | | terminal end | | | |
| Example 9-2 | Ag | Thiol group | 5 | ⊚ | ◯ |
| | | terminal end | | | |
| Example 9-3 | Pd | Thiol group | 10 | ⊚ | ◯ |
| | | terminal end | | | |
| Example 9-4 | Cu | Thiol group | 50 | ◯ | ◯ |
| | | terminal end | | | |
| Example 9-5 | Pt | Thiol group | 20 | ◯ | ◯ |
| | | terminal end | | | |
| Example 9-6 | Au | Carboxy group | 8 | Δ | Δ |
| | | terminal end | | | |

In Table 5, criteria are double circle: a monolayer array and 400 or more particles on average in a regularly arranged region, ◯: a monolayer array and 100 or more particles on average in a regularly arranged region, Δ: a monolayer array was possible or slightly difficult to obtain, and X: no monolayer array was formed.

Aggregation suppression was checked by measuring a square region of 10 μm side with an SEM, and evaluated by ◯: no aggregation was found, Δ: some aggregation was found, and X: aggregation was found.

After coating of the particles of Example 9, good monolayer arrays were formed, and no aggregation was found. These results demonstrate that like the Fe particles which reacted with the protective group at the carboxy group terminal end, the surfaces of the particles of Example 9 reacted with the thiol group, and it was possible to secure good coating properties. Also, no aggregation occurred even when a viscosity modifier having a high viscosity was mixed. This shows that an aggregation suppressing effect was obtained.

On the other hand, after a dispersion of the Au particles tried as Example 9-6 was prepared, the particles slightly aggregated and precipitated with time. A cause for this was that the particles did not react with polystyrene having a carboxy group terminal end, so the viscosity modifier and Au particles were readily separable.

The above results reveal that good coating properties were obtained by the grains disclosed in this example.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording medium manufacturing method comprising:
forming a magnetic recording layer on a substrate;
forming a mask layer on the magnetic recording layer;
coating the mask layer with a fine particle coating solution containing fine particles including a protective group having a surface polarity close to that of the mask layer and containing, on at least surfaces thereof, a material selected from the group consisting of aluminum, titanium, vanadium, chromium, manganese, iron, cobalt, nickel, zinc, yttrium, zirconium, tin, molybdenum, tantalum, tungsten, gold, silver, palladium, copper, platinum, and oxides thereof, a viscosity modifier, and a solvent for adjusting mixing of the viscosity modifier and the fine particles having the protective group, to form a fine particle monolayer on the mask layer;
transferring a periodic pattern formed by the fine particle layer to the mask layer;
transferring the periodic pattern to the magnetic recording layer; and
removing the mask layer from the magnetic recording layer.

2. The method according to claim 1, further comprising, before the forming the fine particle layer, forming a dispersion by dispersing a protective group material having a surface polarity close to that of the mask layer and the fine particles in the solvent, bonding the protective group to the fine particles in the dispersion, and mixing a viscosity modifier in the dispersion of the fine particles including the protective group to prepare the fine particle coating solution.

3. The method according to claim 2, wherein the protective group material contains at least one main chain selected from the group consisting of a saturated hydrocarbon, an unsaturated hydrocarbon having a plurality of carbon double bonds, polyester, polystyrene, polymethylmethacrylate, polyallylether, polyvinylether, polyacrylic ester, polymethacrylic ester, and derivatives thereof, and a functional group bonded at a terminal end of the main chain, consisting of at least one of a carboxy group and a thiol group.

4. The method according to claim 3, wherein the fine particles contain, on at least surfaces thereof, a material selected from the group consisting of aluminum, titanium, vanadium, chromium, manganese, iron, cobalt, nickel, zinc, yttrium, zirconium, tin, molybdenum, tantalum, tungsten, and oxides thereof, and the protective group material contains at least one main chain selected from the group consisting of a saturated hydrocarbon, an unsaturated hydrocarbon having a plurality of carbon double bonds, polyester, polystyrene, polymethylmethacrylate, polyallylether, polyvinylether, polyacrylic ester, polymethacrylic ester, and derivatives thereof, and a functional group bonded at a terminal end of the main chain, consisting of a carboxy group.

5. The method according to claim 3, wherein the fine particles contain, on at least surfaces thereof, a material selected from the group consisting of gold, silver, palladium, copper, platinum, and oxides thereof, and the protective group material contains at least one main chain selected from the group consisting of a saturated hydrocarbon, an unsaturated hydrocarbon having a plurality of carbon double bonds, polyester, polystyrene, polymethylmethacrylate, polyallylether, polyvinylether, polyacrylic ester, polymethacrylic ester, and derivatives thereof, and a functional group bonded at a terminal end of the main chain, consisting of a thiol group.

6. The method according to claim 3, wherein the main chain of the protective group material is polystyrene.

7. The method according to claim 2, wherein the number of protective groups in the dispersion is 0.1 to 100 groups/nm² per surface area of the fine particles.

8. The method according to claim 1, wherein the viscosity modifier is at least one material selected from polymerizable materials having a viscosity of 10 to 5,000 cps and a molecular weight of 100 to 1,000, and containing an acryloyl group, a methacryloyl group, an epoxy group, an oxetane ring, and a vinyl ether group.

9. The method according to claim 1, wherein the solvent is selected from the group consisting of hexane, toluene, xylene, cyclohexane, cyclohexanone, propylene glycol 1-monomethyl ether 2-acetate, diglyme, ethyl lactate, methyl lactate, and tetrahydrofuran.

10. The method according to claim 1, wherein coating of the fine particle coating solution is performed by using one of a spin coating method, a dip coating method, and an LB method.

11. A magnetic recording medium manufacturing method comprising:
coating a substrate with a fine particle coating solution containing fine particles including a protective group having a surface polarity close to that of the substrate, and containing, on at least surfaces thereof, a material selected from the group consisting of aluminum, titanium, vanadium, chromium, manganese, iron, cobalt, nickel, zinc, yttrium, zirconium, tin, molybdenum, tantalum, tungsten, gold, silver, palladium, copper, platinum, and oxides thereof, a viscosity modifier, and a solvent which adjusts mixing of the viscosity modifier and the fine particles including the protective group to form a fine particle monolayer on the substrate; and
forming a magnetic recording layer on a periodic pattern formed by the fine particles.

12. The method according to claim 11, further comprising, before the forming the fine particle layer, forming a dispersion by dispersing a protective group material having a surface polarity close to that of the substrate and the fine particles in the solvent, bonding the protective group to the fine particles in the dispersion, and mixing a viscosity modifier in the dispersion of the fine particles including the protective group to prepare the fine particle coating solution.

13. The method according to claim 12, wherein the protective group material contains at least one main chain selected from the group consisting of a saturated hydrocarbon, an unsaturated hydrocarbon having a plurality of carbon double bonds, polyester, polystyrene, polymethylmethacrylate, polyallylether, polyvinylether, polyacrylic ester, polymethacrylic ester, and derivatives thereof, and a functional group bonded at a terminal end of the main chain, consisting of at least one of a carboxy group and a thiol group.

14. The method according to claim 13, wherein the fine particles contain, on at least surfaces thereof, a material selected from the group consisting of aluminum, titanium, vanadium, chromium, manganese, iron, cobalt, nickel, zinc, yttrium, zirconium, tin, molybdenum, tantalum, tungsten, and oxides thereof, and the protective group material contains at least one main chain selected from the group consisting of a saturated hydrocarbon, an unsaturated hydrocarbon having a plurality of carbon double bonds, polyester, polystyrene, polymethylmethacrylate, polyallylether, polyvinylether, polyacrylic ester, polymethacrylic ester, and derivatives thereof, and a functional group bonded at a terminal end of the main chain, consisting of a carboxy group.

15. The method according to claim 13, wherein the fine particles contain, on at least surfaces thereof, a material selected from the group consisting of gold, silver, palladium, copper, platinum, and oxides thereof, and the protective group material contains at least one main chain selected from the group consisting of a saturated hydrocarbon, an unsaturated hydrocarbon having a plurality of carbon double bonds, polyester, polystyrene, polymethylmethacrylate, polyallylether, polyvinylether, polyacrylic ester, polymethacrylic ester, and derivatives thereof, and a functional group bonded at a terminal end of the main chain, consisting of a thiol group.

16. The method according to claim 13, wherein the main chain of the protective group material is polystyrene.

17. The method according to claim 12, wherein the number of protective groups in the dispersion is 0.1 to 100 groups/nm² per surface area of the fine particles.

18. The method according to claim 11, wherein the viscosity modifier is at least one material selected from polymerizable materials having a viscosity of 10 to 5,000 cps and a molecular weight of 100 to 1,000, and containing an acryloyl group, a methacryloyl group, an epoxy group, an oxetane ring, and a vinyl ether group.

19. The method according to claim 11, wherein the solvent is selected from the group consisting of hexane, toluene, xylene, cyclohexane, cyclohexanone, propylene glycol 1-monomethyl ether 2-acetate, diglyme, ethyl lactate, methyl lactate, and tetrahydrofuran.

20. The method according to claim 11, wherein coating of the fine particle coating solution is performed by using one of a spin coating method, a dip coating method, and an LB method.

21. A pattern formation method comprising coating a substrate with a fine particle coating solution containing fine particles including a protective group having a surface polarity close to that of the substrate, and containing, on at least surfaces thereof, a material selected from the group consisting of aluminum, titanium, vanadium, chromium, manganese, iron, cobalt, nickel, zinc, yttrium, zirconium, tin, molybdenum, tantalum, tungsten, gold, silver, palladium, copper, platinum, and oxides thereof, a viscosity modifier, and a solvent which adjusts mixing of the viscosity modifier and the fine particles including the protective group to form a fine particle layer on the substrate.

22. The method according to claim 21, further comprising, before the forming the fine particle layer, forming a dispersion by dispersing a protective group material having a surface polarity close to that of the substrate and the fine particles in the solvent, bonding the protective group to the fine particles in the dispersion, and mixing a viscosity modifier in the dispersion of the fine particles including the protective group to prepare the fine particle coating solution.

23. The method according to claim 22, wherein a material of the protective group contains at least one main chain selected from the group consisting of a saturated hydrocarbon, an unsaturated hydrocarbon having a plurality of carbon double bonds, polyester, polystyrene, polymethylmethacrylate, polyallylether, polyvinylether, polyacrylic ester, polymethacrylic ester, and derivatives thereof, and a functional group bonded at a terminal end of the main chain, consisting of at least one of a carboxy group and a thiol group.

24. The method according to claim 23, wherein the fine particles contain, on at least surfaces thereof, a material selected from the group consisting of aluminum, titanium, vanadium, chromium, manganese, iron, cobalt, nickel, zinc, yttrium, zirconium, tin, molybdenum, tantalum, tungsten, and oxides thereof, and the protective group material contains at least one main chain selected from the group consisting of a saturated hydrocarbon, an unsaturated hydrocarbon having a plurality of carbon double bonds, polyester, polystyrene, polymethylmethacrylate, polyallylether, polyvinylether, polyacrylic ester, polymethacrylic ester, and derivatives thereof, and a functional group bonded at a terminal end of the main chain, consisting of a carboxy group.

25. The method according to claim 23, wherein the fine particles contain, on at least surfaces thereof, a material selected from the group consisting of gold, silver, palladium, copper, platinum, and oxides thereof, and the protective group material is at least one material selected from the group consisting of a saturated hydrocarbon, an unsaturated hydrocarbon having a plurality of carbon double bonds, polyester, polystyrene, polymethylmethacrylate, polyallylether, polyvinylether, polyacrylic ester, polymethacrylic ester, and derivatives thereof, and a functional group bonded at a terminal end of the main chain, consisting of a thiol group.

26. The method according to claim 23, wherein the main chain of the material of the protective group is polystyrene.

27. The method according to claim 22, wherein the number of protective groups in the dispersion is 0.1 to 100 groups/nm² per surface area of the fine particles.

28. The method according to claim 21, wherein the viscosity modifier is at least one material selected from polymerizable materials having a viscosity of 10 to 5,000 cps and a molecular weight of 100 to 1,000, and containing an acryloyl group, a methacryloyl group, an epoxy group, an oxetane ring, and a vinyl ether group.

29. The method according to claim 21, wherein the solvent is selected from the group consisting of hexane, toluene, xylene, cyclohexane, cyclohexanone, propylene glycol 1-monomethyl ether 2-acetate, diglyme, ethyl lactate, methyl lactate, and tetrahydrofuran.

30. The method according to claim 21, wherein coating of the fine particle coating solution is performed by using one of a spin coating method, a dip coating method, and an LB method.

31. A fine particle dispersion comprising fine particles including a protective group having a surface polarity close to that of a substrate, and containing, on at least surfaces thereof, a material selected from the group consisting of aluminum, titanium, vanadium, chromium, manganese, iron, cobalt, nickel, zinc, yttrium, zirconium, tin, molybdenum, tantalum, tungsten, gold, silver, palladium, copper, platinum, and oxides thereof, a viscosity modifier, and a solvent which adjusts mixing of the viscosity modifier and, the fine particles including the protective group.

32. The dispersion according to claim 31, wherein the protective group is bonded to the fine particles in a dispersion in which a protective group material having a surface polarity close to that of the substrate and the fine particles are dispersed in the solvent, and the number of protective groups in the dispersion is 0.1 to 100 groups/nm² per surface area of the fine particles.

33. The dispersion according to claim 31, wherein, the protective group is bonded to the fine particles in a dispersion in which a protective group material having a surface polarity close to that of the substrate and the fine particles are dispersed in the solvent, the protective group material contains at least one main chain selected from the group consisting of a saturated hydrocarbon, an unsaturated hydrocarbon having a plurality of carbon double bonds, polyester, polystyrene, polymethylmethacrylate, polyallylether, polyvinylether, polyacrylic ester, polymethacrylic ester, and derivatives thereof, and a functional group bonded at a terminal end of the main chain, consisting of at least one of a carboxy group and a thiol group.

34. The dispersion according to claim 33, wherein the fine particles contain, on at least surfaces thereof, a material selected from the group consisting of aluminum, titanium, vanadium, chromium, manganese, iron, cobalt, nickel, zinc, yttrium, zirconium, tin, molybdenum, tantalum, tungsten, and oxides thereof, and the protective group material contains at least one main chain selected from the group consisting of a saturated hydrocarbon, an unsaturated hydrocarbon having a plurality of carbon double bonds, polyester, polystyrene, polymethylmethacrylate, polyallylether, polyvinylether, polyacrylic ester, polymethacrylic ester, and derivatives thereof, and a functional group bonded at a terminal end of the main chain, consisting of a carboxy group.

35. The dispersion according to claim 33, wherein the fine particles contain, on at least surfaces thereof, a material selected from the group consisting of gold, silver, palladium, copper, platinum, and oxides thereof, and the protective group material contains at least one main chain selected from the group consisting of a saturated hydrocarbon, an unsaturated hydrocarbon having a plurality of carbon double bonds, polyester, polystyrene, polymethylmethacrylate, polyallylether, polyvinylether, polyacrylic ester, polymethacrylic ester, and derivatives thereof and a functional group bonded at a terminal end of the main chain, consisting of a thiol group.

36. The dispersion according to claim 31, wherein the solvent is selected from the group consisting of hexane, toluene, xylene, cyclohexane, cyclohexanone, propylene glycol 1-monomethyl ether 2-acetate, diglyme, ethyl lactate, methyl lactate, and tetrahydrofuran.
